(19) United States
(12) Patent Application Publication
(10) Pub. No.: US 2014/0370426 A1
(43) Pub. Date: Dec. 18, 2014

(54) NON-MAGNETIC SINGLE-COMPONENT TONER, ELECTROSTATIC CHARGE IMAGE DEVELOPER, AND PROCESS CARTRIDGE

(71) Applicant: FUJI XEROX CO., LTD., Tokyo (JP)

(72) Inventors: Daisuke ISHIZUKA, Kanagawa (JP); Shinichi YAOI, Kanagawa (JP); Tomoaki TANAKA, Kanagawa (JP); Seijiro ISHIMARU, Kanagawa (JP); Kotaro YOSHIHARA, Kanagawa (JP); Yasushige NAKAMURA, Kanagawa (JP)

(73) Assignee: FUJI XEROX CO., LTD., Tokyo (JP)

(21) Appl. No.: 14/061,116

(22) Filed: Oct. 23, 2013

(30) Foreign Application Priority Data
Jun. 12, 2013 (JP) 2013-123401

(51) Int. Cl. G03G 9/00

(52) U.S. Cl. CPC G03G 9/08755; G03G 21/18
USPC 430/105; 430/108.4; 430/108.2

(57) ABSTRACT

A non-magnetic single-component toner includes a toner base particle that contains at least a binder resin and a colorant, and an external additive, wherein the external additive includes an organic particle and an inorganic particle, the binder resin contains at least an amorphous polyester resin and a crystalline polyester resin, an endothermic peak of the crystalline polyester resin obtained by differential scanning calorimetry is from 50° C. to 100° C., the organic particle contains at least one kind selected from a group consisting of higher fatty acid, higher alcohol, fatty acid ester, and fatty acid amide, and the inorganic particle is treated with silicone oil.

### CROSS-REFERENCE TO RELATED APPLICATIONS

This application is based on and claims priority under 35 USC 119 from Japanese Patent Application No. 2013-123401 filed Jun. 12, 2013.

### BACKGROUND

1. Technical Field

The present invention relates to a non-magnetic single-component toner, an electrostatic charge image developer, and a process cartridge.

2. Related Art

In recent years, along with the development of devices and enhancement of communication networks of the information society, an electrophotographic process is widely used in a network printer in an office, a printer for a personal computer, and an on-demand printer, not only a copier; and high quality, high speed, high reliability, miniaturization, reduction in size and energy saving properties are strongly becoming required more and more, regardless of the printing being black and white or color.

Normally, in the electrophotographic process, a fixed image is formed through a plurality of steps including, electrically forming an electrostatic charge image on a photoreceptor (image holding member) obtained by using a photoconductive material by various units, developing this electrostatic charge image by using toner, transferring the toner image on the photoreceptor to a recording medium such as paper or the like through or without an intermediate transfer member, and fixing this transferred image onto the recording medium.

A single-component developing method is provided as one developing method performed by electrophotography. The single-component developing method is broadly divided into a magnetic single-component developing method using a magnetic toner and a non-magnetic single-component developing method using a non-magnetic toner, and the non-magnetic single-component developing method is selected in many cases, from a viewpoint of coloring.

### SUMMARY

According to an aspect of the invention, there is provided a non-magnetic single-component toner including: a toner base particle that contains at least a binder resin and a colorant, and an external additive, wherein the external additive includes an organic particle and an inorganic particle, the binder resin contains at least an amorphous polyester resin and a crystalline polyester resin, an endothermic peak of the crystalline polyester resin obtained by differential scanning calorimetry is from 50° C. to 100° C., the organic particle contains at least one kind selected from a group consisting of higher fatty acid, higher alcohol, fatty acid ester, and fatty acid amide, and the inorganic particle is treated with silicone oil.

### BRIEF DESCRIPTION OF THE DRAWINGS

Exemplary embodiments of the present invention will be described in detail based on the following figures, wherein:

FIG. 1 is a schematic cross-sectional view showing an example of a tandem image forming apparatus which is suitably used in the exemplary embodiment; and

FIG. 2 is a schematic outline diagram showing an example of a developing device using a non-magnetic single-component toner or a non-magnetic single-component developer of the exemplary embodiment.

### DETAILED DESCRIPTION

Non-magnetic single-component toner (hereinafter, also simply referred to as “toner”) of the exemplary embodiment contains a toner base particle (hereinafter, also simply referred to as a “base particle”) containing at least a binder resin and a colorant, and an external additive, in which the external additive contains an organic particle and an inorganic particle, the binder resin contains at least an amorphous polyester resin and a crystalline polyester resin, an endothermic peak obtained by differential scanning calorimetry of the crystalline polyester resin is from 50° C. to 100° C., the organic particle contains at least one kind selected from a group consisting of higher fatty acid, higher alcohol, fatty acid ester, and fatty acid amide, and the inorganic particle is treated with silicone oil (hereinafter, also referred to as a “silicone oil-treated inorganic particle”).

In the exemplary embodiment, the phrase “from X to Y” does not only indicate a range between X and Y, but also indicates a range including X and Y which are at the end of the range. For example, if the phrase “from X to Y” is a numerical range, it indicates “from X to Y” or “from Y to X” according to the numerical values.

The non-magnetic single-component contact developing method is used for the toner of the exemplary embodiment, and toner which is used in an image forming apparatus using a cleaner-less (cleaning simultaneously while developing) method is preferable.

In the related art, particularly in the cleaner-less system, since there is no cleaning blade for removing adhered matter on the surface of the image holding member (photoreceptor), toner components such as wax components or external additive components, paper components, and the like may be adhered to and accumulated on the surface thereof. Particularly, in the adhered state of the toner component, differences are generated in the adhered state among the surface of the photoreceptor, depending on the printing history. In a state where the toner is not degraded, since the external additive on the surface of the toner maintains the adhesion force between the toner and the photoreceptor in an appropriate range, such differences of the adhered state of the surface of the photoreceptor does not largely affect a toner transfer property obtained by the photoreceptor surface state and does not largely affect the image quality.

As a result of the consideration, the inventors have found that, in a state where the toner degradation such as detachment, embed, and deformation of the external additive due to mechanical stress by the developing apparatus is excessively proceeded, the toner transfer property is slightly changed due to the adhered matter state of the photoreceptor surface, and this may be appeared as differences in shade at the time of printing a half-tone image. It is found that such a problem is more significant, particularly when performing high speed development.

In addition, the inventors have studied the problem of unevenness of the half-tone image, and found that by employing a silicone oil-treated inorganic particle and a specific organic particle as external additives and using a toner base particle containing a crystalline resin, evenness of the half-tone image is obtained even in a state where the toner degradation is proceeded, and thus the present invention is completed. The mechanism thereof is not always clear, thus, the following operation mechanism is assumed.

When the silicone oil-treated inorganic particle is added, free silicone oil is adhered to the photoreceptor by sliding of the toner and the photoreceptor due to a contact phenomenon. The adhered silicone oil stabilizes the adhesion force between the toner particle and the photoreceptor, and the adhesiveness of the toner component to the photoreceptor is suppressed. However, in a case of simply adding the silicone oil-treated inorganic particle, the silicone-oil treated inorganic particle is easily accumulated on a toner carrier having elasticity and toner transportability is impaired, and accordingly the half-tone image unevenness occurs due to transportation unevenness.

Meanwhile, in the exemplary embodiment, since the adhesion force between the organic particle and the silicone oil-treated inorganic particle is larger than the adhesion force between the toner carrier and the silicone oil-treated inorganic particle, the adhesiveness with the toner carrier is prevented. In addition, since the organic particle has high adhesiveness with the crystalline polyester resin component which exists on the surface of the toner base particle, the organic particle to which the silicone oil-treated inorganic particle is adhered is also adhered to the toner, and is discharged to the outside of a cartridge with the toner at the time of development. Therefore, the silicone oil-treated inorganic particle is not accumulated in the cartridge and the transportability of the toner is not impaired. That is, it is assumed that, by appropriately maintaining the adhesion force between the organic particle and the toner base particle, the transportability impairment due to the silicone oil-treated inorganic particle may be prevented and the oil application to the photoreceptor surface and removing the adhered matter may be stably performed.

### 1. Non-Magnetic Single-Component Toner

### 1-1. Toner Base Particle

The non-magnetic single-component toner of the exemplary embodiment contains a toner base particle and an external additive, and the toner base particle contains a binder resin and a colorant.

### (1) Binder Resin

In the exemplary embodiment, the toner base particle contains the binder resin, and the binder resin contains at least an amorphous polyester resin and a crystalline polyester resin.

### Crystalline Polyester Resin

In the exemplary embodiment, the toner base particle contains the crystalline polyester resin as the binder resin, and an endothermic peak obtained by differential scanning calorimetry of the crystalline polyester resin is equal to or higher than 50° C. and lower than 100° C.

The crystalline polyester resin of the exemplary embodiment will be described, hereinafter. In the exemplary embodiment, the “crystallinity” indicates having a definite endothermic peak in the differential scanning calorimetry (DSC) and, in particular, means having a half-value width of the endothermic peak when measuring at a temperature rising rate of 10° C./min being within 15° C. On the other hand, a resin with a half-value width of the endothermic peak exceeding 15° C. or a resin without definite endothermic peak means it is amorphous.

The crystalline polyester resin is synthesized from an acid (polycarboxylic acid, preferably dicarboxylic acid) component, and an alcohol (polyol, preferably diol) component. In addition, in the exemplary embodiment, a copolymer which is obtained by copolymerization with the other component at a ratio of equal to or less than 50% by weight, with respect to a main chain of the crystalline polyester resin is also considered as the crystalline polyester resin.

Aliphatic dicarboxylic acid is preferably contained as the acid (polycarboxylic acid) component. Examples thereof include oxalic acid, malonic acid, succinic acid, glutaric acid, adipic acid, pimelic acid, suberic acid, aselin acid, sebacic acid, 1,9-nonanedicarboxylic acid, 1,10-decanedicarboxylic acid, 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, 1,18-octadecanedicarboxylic acid, and the like, or lower alkylester thereof, or acid anhydride thereof. In addition, a dicarboxylic acid component having ethylenic unsaturated bond such as fumaric acid, maleic acid, 3-hexenedioic acid, 3-octenedioic acid may be contained.

On the other hand, the aliphatic diol is preferably contained as the alcohol (polyol) component, and examples thereof include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,20-eicosanediol, and the like, however there is no limitation.

In the exemplary embodiment, the endothermic peak of the crystalline polyester resin obtained by the differential scanning calorimetry is from 50° C. to 100° C. If it is equal to or higher than 50° C., the adhesion force with the photoreceptor does not become excessive and an excellent half-tone image may be obtained. If it is equal to or lower than 100° C., an appropriate adhesion force may be applied to the toner base particle and the organic particle, and the toner transportability impairment may be prevented.

The endothermic peak of the crystalline polyester resin obtained by the differential scanning calorimetry is preferably from 55° C. to 95° C., more preferably from 58° C. to 90° C., and even more preferably 60° C. to 85° C.

The endothermic peak of the crystalline polyester resin is measured using a differential scanning calorimeter (DSC), and may be acquired as a melting peak temperature of input compensation differential scanning calorimetry shown based on JIS K-7121 at the time of performing measurement at a temperature rising rate of 10° C. per minute in a room temperature (20° C.) up to 150° C. The crystalline resin has a plurality of melting peaks, in some cases, however, in the exemplary embodiment, the maximum peak is considered as the endothermic peak.

To have the endothermic peak of the crystalline polyester resin obtained by the differential scanning calorimetry from 50° C. to 100° C., the acid component and the alcohol component to be used, and the composition ratio thereof are preferably appropriately selected and it is preferable to follow the conventional method. For example, a melting temperature may be increased by increasing carbon atoms of the aliphatic dicarboxylic acid or the aliphatic diol component or by using an aromatic dicarboxylic acid in addition to the aliphatic dicarboxylic acid.

The content of the crystalline polyester resin with respect to the toner base particle is preferably from 3% by weight to 40% by weight. The content thereof is more preferably from 4% by weight to 30% by weight, and even more preferably from 5% by weight to 25% by weight.

If the content of the crystalline polyester resin in the toner base particle is in the range described above, the adhesiveness with the organic particle is suitably maintained.

### Amorphous Polyester Resin

In the exemplary embodiment, the toner base particle contains the amorphous polyester resin as the binder resin. In the exemplary embodiment, a well-known amorphous polyester resin may be used as the amorphous polyester resin.

As the acid component, various dicarboxylic acids which are exemplified in regards to the crystalline polyester resin may be used in the same manner. In addition, aromatic dicarboxylic acids such as phthalic acid, isophthalic acid, terephthalic acid, succinic acid substituted with an alkyl group having 1 to 20 carbon atoms or an alkenyl group having 2 to 20 carbon atoms such as dodecenylsuccinic acid and octyl succinic acid, anhydride of these acids, and alkyl (1 to 8 carbon atoms, preferably 1 to 3 carbon atoms) ester of these acids are preferably used.

Further, as trivalent or higher valent carboxylic acid, trimellitic acid, pyromellitic acid, 1,2,4-cyclohexane tricarboxylic acid, 2,5,7-naphthalenetricarboxylic acid, 1,2,4-naphthalenetricarboxylic acid, 1,2,5-hexanetricarboxylic acid, 1,2,7,8-octanetetracarboxylic acid, or acid anhydride or lower alkyl ester thereof may be used. These may be used alone as one kind or in combination of two or more kinds.

Also as the alcohol component, various diols to be used for synthesis of the crystalline polyester resin may be used, however, in addition to the aliphatic diol exemplified in regards to the crystalline polyester resin, bisphenol A alkylene (2 to 3 carbon atoms) oxide (number of average additive moles of 1 to 10) adduct such as polyoxypropylene (2.2)-2,2-bis(4-hydroxyphenyl)propane or polyoxyethylene (2.2)-2,2-bis(4-hydroxyphenyl)propane, or hydrogenated bisphenol A may be used. In addition, examples of the trivalent or higher valent alcohol include aliphatic polyol having 3 to 20 carbon atoms such as sorbitol, 1,2,3,6-hexane tetrol, 1,4-sorbitan, pentaerythritol, di-pentaerythritol, tripentaerythritol, 1,2,4-butanetriol, 1,2,5-pentanetriol, glycerol, 2-methylpropane triol, 2-methyl-1,2,4-butanetriol, trimethylolethane, and trimethylolpropane, aromatic polyol having 6 to 20 carbon atoms such as 1,3,5-trihydroxylmethylbenzene, and alkylene oxide adduct thereof. These may be used alone as one kind or in combination of two or more kinds.

A glass transition temperature Tg of the amorphous polyester resin is preferably from 40° C. to 80° C., and more preferably from 45° C. to 70° C. If the Tg is equal to or higher than 40° C., fluidity of the toner particle may be suitably maintained even at a high temperature, and if the Tg is equal to or lower than 80° C., sufficient melting is performed and the lowest fixing temperature is set to be lower.

The glass transition temperature of the binder resin is a value measured by the method (DSC method) regulated based on ASTM D3418-82.

The content of the amorphous polyester resin with respect to the toner base particle is preferably from 50% by weight to 95% by weight. The content thereof is more preferably from 55% by weight to 92% by weight, and even more preferably from 60% by weight to 90% by weight.

If the content of the amorphous polyester resin in the toner base particle is in the range described above, the adhesiveness with the organic particle is suitably maintained.

In addition, the weight-average molecular weight of the polyester resin used in the exemplary embodiment is preferably from 4,000 to 100,000, and more preferably from 6,000 to 80,000. If the weight-average molecular weight thereof is equal to or more than 4,000, an excellent cohesive force may be obtained as the binder resin and an excellent hot offset property is obtained. In addition, if the weight-average molecular weight thereof is equal to or less than 100,000, suitable lowest fixing temperature may be obtained.

In addition, the polyester resin used in the exemplary embodiment may have partial branching or a bridge structure, by selection of valence of carboxylic acid and valence of alcohol of polycondensation monomer.

In addition, as the binder resin, well-known resins may be used in combination other than the crystalline polyester resin and the amorphous polyester resin.

Other than the polyester resin as the binder resin, a copolymer of styrene and acrylic acid or methacrylic acid, polyvinyl chloride resins, phenol resins, acrylic resins, methacrylic resins, polyvinyl acetate, silicone resins, polyurethane resins, polyamide resins, furan resins, epoxy resins, xylene resins, polyvinyl butyral, terpene resin, coumarone-indene resin, petroleum resin, polyether polyol resin, and the like may also be used in combination as the binder resin.

The content of the binder resin in the toner base particle is preferably 50% by weight to 98% by weight, more preferably from 55% by weight to 96% by weight, and even more preferably from 60% by weight to 94% by weight. If the content of the binder resin is in the range described above, excellent fixing property is obtained.

### (2) Colorant

In the exemplary embodiment, the toner base particle contains a colorant.

A well-known colorant may be used as the colorant, and arbitrary selection may be performed from viewpoints of a hue angle, color saturation, lightness, weather resistance, OHP transparency, dispersibility in the toner, and the like.

The colorant may be a dye or a pigment, however, is preferably a pigment from a viewpoint of lightfastness or waterfastness. In addition, the colorant is not limited to the chromatic colorant, and may be a white colorant, and a colorant having a metal color.

For example, in the cyan toner, examples of the colorant thereof include a cyan pigment such as C.I. Pigment Blue 1, C.I. Pigment Blue 2, C.I. Pigment Blue 3, C.I. Pigment Blue 4, C.I. Pigment Blue 5, C.I. Pigment Blue 6, C.I. Pigment Blue 7, C.I. Pigment Blue 10, C.I. Pigment Blue 11, C.I. Pigment Blue 12, C.I. Pigment Blue 13, C.I. Pigment Blue 14, C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 15:6, C.I. Pigment Blue 16, C.I. Pigment Blue 17, C.I. Pigment Blue 23, C.I. Pigment Blue 60, C.I. Pigment Blue 65, C.I. Pigment Blue 73, C.I. Pigment Blue 83, C.I. Pigment Blue 180, C.I. Vat Cyan 1, C.I. Vat Cyan 3, C.I. Vat Cyan 20, Iron Blue, Cobalt Blue, Alkali Blue Lake, Phthalocyanine Blue, Free-metal Phthalocyanine Blue, Partial Chlorine Compound of Phthalocyanine Blue, Fast Sky Blue, Indanthrene Blue BC, a cyan dye such as C.I. Solvent Cyan 79, 162, and the like.

In the magenta toner, examples of the colorant thereof include magenta pigments such as C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 13, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 39, C.I. Pigment Red 40, C.I. Pigment Red 41, C.I. Pigment Red 48, C.I. Pigment Red 49, C.I. Pigment Red 70, C.I. Pigment Red 51, C.I. Pigment Red 52, C.I. Pigment Red 53, C.I. Pigment Red 54, C.I. Pigment Red 55, C.I. Pigment Red 57, C.I. Pigment Red 58, C.I. Pigment Red 60, C.I. Pigment Red 63, C.I. Pigment Red 64, C.I. Pigment Red 68, C.I. Pigment Red 81, C.I. Pigment Red 83, C.I. Pigment Red 87, C.I. Pigment Red 88, C.I. Pigment Red 89, C.I. Pigment Red 90, C.I. Pigment Red 112, C.I. Pigment Red 114, C.I. Pigment Red 122, C.I. Pigment Red 123, C.I. Pigment Red 163, C.I. Pigment Red 184, C.I. Pigment Red 185, C.I. Pigment Red 202, C.I. Pigment Red 206, C.I. Pigment Red 207, C.I. Pigment Red 209, C.I. Pigment Red 238, and the like, Pigment Violet 19, magenta dyes such as C.I. Solvent Red 1, C.I. Solvent Red 3, C.I. Solvent Red 8, C.I. Solvent Red 23, C.I. Solvent Red 24, C.I. Solvent Red 25, C.I. Solvent Red 27, C.I. Solvent Red 30, C.I. Solvent Red 49, C.I. Solvent Red 81, C.I. Solvent Red 82, C.I. Solvent Red 83, C.I. Solvent Red 84, C.I. Solvent Red 100, C.I. Solvent Red 109, C.I. Solvent Red 121, C.I. Disperse Red 9, C.I. Basic Red 1, C.I. Basic Red 2, C.I. Basic Red 9, C.I. Basic Red 12, C.I. Basic Red 13, C.I. Basic Red 14, C.I. Basic Red 15, C.I. Basic Red 17, C.I. Basic Red 18, C.I. Basic Red 22, C.I. Basic Red 23, C.I. Basic Red 24, C.I. Basic Red 27, C.I. Basic Red 29, C.I. Basic Red 32, C.I. Basic Red 34, C.I. Basic Red 35, C.I. Basic Red 36, C.I. Basic Red 37, C.I. Basic Red 38, C.I. Basic Red 39, C.I. Basic Red 40, red iron oxide, cadmium red, red lead, mercuric sulfide, cadmium, Permanent Red 4R, Lithol Red, pyrazolone red, watching red, calcium salt, Lake Red D, Brilliant Carmine 6B, Eosin Lake, Rhodamine Lake B, Alizarin Lake, Brilliant Carmine 3B, and the like.

In the yellow toner, examples of the colorant thereof include yellow pigments such as C.I. Pigment Yellow 2, C.I. Pigment Yellow 3, C.I. Pigment Yellow 15, C.I. Pigment Yellow 16, C.I. Pigment Yellow 17, C.I. Pigment Yellow 74, C.I. Pigment Yellow 93, C.I. Pigment Yellow 97, C.I. Pigment Yellow 128, C.I. Pigment Yellow 155, C.I. Pigment Yellow 180, C.I. Pigment Yellow 185, C.I. Pigment Yellow 139, and the like.

In addition, in the black toner, examples of the colorant thereof include carbon black, activated carbon, titanium black, magnetic powder, Mn-contained non-magnetic powder, and the like. In addition, a mixture of the yellow, magenta, cyan, red, green, and blue pigments may be used as the black toner.

As the colorant, a surface-treated colorant may be used or a pigment dispersant may be used. By selecting the kind of the colorant, the color toner such as the yellow toner, the magenta toner, the cyan toner, and the black toner are prepared.

The amount of the colorant used is preferably from 0.1 part by weight to 20 parts by weight, and more preferably from 0.5 part by weight to 15 parts by weight, with respect to 100 parts by weight of the toner base particle. As the colorant, the pigments or dyes may be used alone as one kind or in combination with two or more kinds.

In the exemplary embodiment, as a toner set including a transparent toner which does not contain a colorant, a color image may be formed. With respect to a color toner image to which gloss is necessary to applied, it is suitably used as a transparent toner for obtaining an excellent gloss image by transferring and fixing on the top or on the periphery thereof.

### (3) Release Agent

In the exemplary embodiment, the toner base particle preferably contains a release agent.

Detailed examples of the release agent are preferably ester wax, polyethylene, polypropylene, or a copolymer of polyethylene and polypropylene, and include unsaturated fatty acids such as polyglycerin wax, microcrystalline wax, paraffin wax, carnauba wax, Sasol wax, montan acid ester wax, deoxidized carnauba wax, palmitic acid, stearic acid, montan acid, piperacillin sodium acid, eleostearic acid, and parinaric acid; saturated alcohols such as stearyl alcohol, aralkyl alcohol, biphenyl alcohol, carnaubyl alcohol, ceryl alcohol, and melissyl alcohol, or long-chain alkyl alcohols having a long chain alkyl group; polyols such as sorbitol; fatty acid amides such as linoleic acid amide, oleic acid amide, lauric acid amide; saturated fatty acid-bis-amides such as methylene-bis-stearic acid amide, ethylene biscaprin acid amide, ethylene bislauric acid amide, and hexamethylene bis stearic acid amide, unsaturated fatty acid amides such as ethylene-bis-oleic acid amide, hexamethylene bis-oleic acid amide, N,N′-dioleyl adipic acid amide, and N,N′-dioleyl sebacic acid amide; aromatic bis amides such as m-xylene bis-stearic acid amide, and N,N′-distearylisophthalic acid amide; fatty acid metal salt such as calcium stearate, calcium laurate, zinc stearate, magnesium stearate (generally called metal soap); wax grafted using a vinyl monomer such as styrene or acrylic acid to aliphatic hydrocarbon wax; partial esterified material of fatty acid and polyol such as monoglyceride behenate; a methylester compound having a hydroxyl group obtained by hydrogenation of vegetable oil; and the like.

The release agents may be used alone as one kind or in combination of two or more kinds. The content of the release agent is preferably in a range of 1% by weight to 20% by weight, and more preferably in a range of 3% by weight to 15% by weight, with respect to 100% by weight of the toner base particle. If the content thereof is in the range described above, both excellent fixation and image quality property may be obtained.

### (4) Other Components

In the exemplary embodiment, in addition to the components described above, the toner base particle may contain other components and a charge-controlling agent is exemplified as the other component.

### Charge-Controlling Agent

In the exemplary embodiment, the charge-controlling agent may be added to the toner base particle to control a charge property of the toner. For example, examples of a positive charge-controlling agent include a nigrosine dye, tributyl benzyl ammonium-1-hydroxy-4-naphtholsulfonic acid salt, quaternary ammonium salt such as tetrabutylammonium tetrafluoroborate, and onium salt such as phosphonium salt which is an analog thereof, and a lake pigment thereof; triphenylmethane dye; metal salt of higher fatty acid; diorganotin oxide such as dibutyltin oxide, dioctyltin oxide, dicyclohexyltin oxide; diorganotin borates such as dibutyltin borate; a guanidine compound, an imidazole compound, an azine compound, and an amino acrylic resin.

In addition, examples of negative charge-controlling agent include a trimethylethane dye, metal complex salt of salicylic acid, metal complex salt of benzyl acid, copper phthalocyanine, perylene, quinacridone, an azo pigment, a metal complex salt azo dye, heavy metal-containing acid dye such as azo chromium complex, calixarene type phenolic condensate, cyclic polysaccharide, and a resin containing a carboxylic group and/or a sulfonyl group.

The charge-controlling agent may be used alone as one kind or in combination of two or more kinds.

The added amount of the charge-controlling agent is preferably from 0% by weight to 10% by weight, more preferably 0% by weight to 8% by weight, and even more preferably from 0% by weight to 6% by weight with respect to the toner base particle. If the added amount thereof is in the range described above, an excellent charge property is obtained.

### 1-2. External Additive

### (1) Organic Particle

In the exemplary embodiment, the non-magnetic single-component toner contains an organic particle as the external additive. The organic particle contains at least one kind selected from a group consisting of higher fatty acid, higher alcohol, fatty acid ester, and fatty acid amide.

By containing the organic particle described above as the external additive in the toner of the exemplary embodiment, the adhesion force with the toner base particle containing the polyester resin and the adhesion force with the silicone oil-treated inorganic particle are efficiently controlled.

As the higher fatty acid, saturated fatty acid having 12 or more carbon atoms is exemplified, detailed examples thereof include lauric acid, myristic acid, palmitic acid, stearic acid, arachidic acid, behenic acid, and lignoceric acid. The upper limit of the number of carbon atoms is not particularly limited, however, from a viewpoint of availability, it is preferably equal to or less than 50, more preferably equal to or less than 45, and even more preferably equal to or less than 40. In addition, a mixture of fatty acids having different number of carbon atoms may be used.

As the higher alcohol, a monovalent fatty alcohol having 14 or more carbon atoms is exemplified, detailed examples thereof include myristyl alcohol, cetyl alcohol, and stearyl alcohol. The upper limit of the number of carbon atoms is not limited, however, from a viewpoint of availability, it is preferably equal to or less than 50, more preferably equal to or less than 45, and even more preferably equal to or less than 40. In addition, a mixture of alcohols having different number of carbon atoms may be used.

As the fatty acid ester, ester of a monovalent fatty acid and a monovalent or polyvalent fatty alcohol is used. In addition to the saturated higher fatty acid, examples of the monovalent fatty acid include saturated fatty acids such as acetic acid, propionic acid, butyric acid, isobutyric acid, valeric acid, isovaleric acid, caproic acid, caprylic acid, and capric acid, hydroxy acid such as glycolic acid, lactic acid, glyceric acid, hydroxy butyric acid, and unsaturated fatty acids such as oleic acid, vaccenic acid, linoleic acid, and linolenic acid.

In addition, examples of the monovalent alcohol include methanol, ethanol, propanol, isopropanol, caprylic alcohol, lauryl alcohol, myristyl alcohol, cetyl alcohol, stearyl alcohol, oleyl alcohol, linoleyl alcohol, and the like. Examples of the divalent alcohol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, and the like. Examples of trivalent or higher valent alcohol include glycerin, pentaerythritol, sorbitol, and the like.

As the fatty acid amide, saturated fatty acid amide, unsaturated fatty acid amide, N-substituted fatty acid amide, and the like are used, and examples thereof include lauric acid amide, stearic acid amide, oleic acid amide, erucic acid amide, ricinoleic acid amide, N,N′-ethylene-bis-lauric acid amide, N,N′-methylene-bis-lauric acid amide, N,N′-ethylene-bis-stearic acid amide, N,N′-ethylene-bis-oleamide, N,N′-ethylene-bis-behenic acid amide, N,N′-ethylene-12-hydroxystearic acid amide, N-oleyl stearic acid amide, N-stearyl stearic acid amide, N-stearyl oleamide, N-oleyl palmitic acid amide, N-stearyl erucic acid amide, stearic acid mono methylolamide, and the like.

The organic particle may be a mixture. In addition, a natural product having at least one kind selected from a group consisting of higher fatty acid, higher alcohol, fatty acid ester, and fatty acid amide, as a main component may be used. Examples of the natural product include carnauba wax, rice wax, Japan wax, beeswax, spermaceti, privet wax, montan wax, and the like.

Among them, as the organic particle, from a viewpoint of adhesiveness with the crystalline polyester resin, fatty acid ester and/or fatty acid amide are particularly preferable.

The organic particle is solid at a room temperature (25° C.), and a melting point thereof is preferably equal to or higher than 50° C., more preferably equal to or higher than 55° C., and even more preferably equal to or higher than 60° C. The upper limit of the melting point is not limited, however, it is preferably equal to or lower than 200° C., more preferably equal to or lower than 180° C., and even more preferably equal to or lower than 150° C.

If the melting point of the organic particle is in the range described above, it is preferable since excellent adhesiveness of the toner base particle and the organic particle is maintained without impairing a heat storage property of the toner.

The average circularity of the organic particle is preferably from 0.70 to 0.95. If the average circularity thereof is equal to or more than 0.70, an excellent half-tone image may be obtained without impairing the transfer property as the toner. If the average circularity thereof is equal to or less than 0.95, suitable adhesion force may be applied to the toner base particle and the organic particle, and the impairing of the toner transportability due to the silicone oil-treated inorganic particle may be prevented. The average circularity thereof is more preferably from 0.75 to 0.94, and even more preferably from 0.80 to 0.93. The average circularity, for example, may be measured by a flow-type particle image analyzer FPIA-3000 (manufactured by Sysmex Corporation).

The number average particle size of the organic particle is preferably from 0.5 μm to 15 μm. If the number average particle size is equal to or larger than 0.5 μm, the suitable adhesion force with the silicone oil-treated inorganic particle may be applied and the impairing of the toner transportability may be prevented. If the number average particle size is equal to or smaller than 15 μm, the suitable adhesion force may be applied to the toner base particle and the organic particle, and the impairing of the toner transportability may be prevented. The number average particle size is more preferably from 1.0 μm to 12 μm, and even more preferably from 3.0 μm to 10 μm.

In addition, as the organic particle, the organic particles other than higher fatty acid, higher alcohol, fatty acid ester, and fatty acid amide may be used in combination. Examples thereof include a vinyl polymer such as a styrene polymer, a (meth)acrylic polymer, and an ethylene polymer, various polymers of melamine-based, amide-based, and allyl phthalate-based, a fluorine-based polymer such as polytetrafluoroethylene, and polyvinylidene fluoride, higher fatty acid metal salt such as zinc stearate.

The added amount of the organic particle is preferably from 0.1 part by weight to 5 parts by weight, more preferably from 0.2 part by weight to 4 parts by weight, and even more preferably from 0.3 part by weight to 3 parts by weight, with respect to 100 parts by weight of the base particle.

If the added amount of the organic particle is in the range described above, it is preferable since the accumulation of the silicone oil-treated inorganic particle to the toner carrier is suitably prevented without impairing the toner transportability.

### (2) Inorganic Particle

The inorganic particle of the exemplary embodiment contains an inorganic particle which is subjected to surface treatment by silicone oil.

Examples of the inorganic particle include silica, alumina, titanium oxide, barium titanate, magnesium titanate, calcium titanate, strontium titanate, zinc oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, silicon nitride, and the like.

Among them, silica, alumina, and titanium oxide are particularly preferable.

Examples of the silicone oil include dimethyl silicone oil, methyl hydrogen silicone oil, methylphenyl silicone oil, amino-modified silicone oils, epoxy-modified silicone oil, carboxyl-modified silicone oil, carbinol-modified silicone oil, methacrylic modified silicone oil, mercapto-modified silicone oil, phenol-modified silicone oil, polyether-modified silicone oil, methylstyryl-modified silicone oil, alkyl-modified silicone oil, higher fatty acid ester-modified silicone oil, higher fatty acid amide-modified silicone oil, fluorine-modified silicone oil, and the like. Among them, dimethyl silicone oil, alkyl-modified silicone oil, higher fatty acid ester-modified silicone oil, and higher fatty acid amide-modified silicone oil are particularly preferable, from a viewpoint of adhesiveness with the organic particle.

The amount of free silicone oil of the silicone oil-treated inorganic particle is preferably from 3% by weight to 20% by weight with respect to the silicone oil-treated inorganic particle. That is, the amount of the free silicone oil is preferably from 3 parts by weight to 20 parts by weight with respect to 100 parts by weight of the silicone oil-treated inorganic particle.

If the amount of the free silicone oil is equal to or more than 3% by weight, the silicone oil may be efficiently applied to the surface of the photoreceptor, and evenness of the half-tone image quality may be obtained. If the amount of the free silicone oil is equal to or less than 20% by weight, evenness of the half-tone image quality may be obtained without impairing the toner transportability.

The amount of the free silicone oil is more preferably from 4% by weight to 18% by weight, and even more preferably from 5% by weight to 15% by weight.

The amount of the free silicone oil may be controlled by a well-known method such as a spray drying method.

The amount of the free silicone oil may be measured, for example, by using proton NMR (AL-400 manufactured by JEOL Ltd. (magnetic field of 9.4T (H nucleus 400 MHz))). The sample (silicone oil-treated inorganic particle), a heavy chloroform solvent, and TMS as a reference material are filled in a zirconia sample tube (diameter of 5 mm). This sample tube is set, and measurement is performed with, for example, a frequency of Δ87 kHz/400 MHz (=Δ20 ppm), a measurement temperature of 25° C., the cumulated number of 16, and degradation ability of 0.24 Hz (about 32000 point). The free surface treatment agent-derived peak intensity is converted into the amount of the free silicone oil using a calibration curve.

For example, in a case where dimethyl silicone oil is used as the silicone oil, the NMR measurement of the untreated inorganic particle base material and the dimethyl silicone oil (shaking an amount of approximately 5 level) is performed, and a calibration curve of the amount of the free silicone oil and NMR peak intensity is provided.

The number average particle size of the silicone oil-treated inorganic particle is preferably from 20 nm to 800 nm. If the number average particle size thereof is equal to or larger than 20 nm, the silicone oil may be efficiently applied to the surface of the photoreceptor, and evenness of the half-tone image quality may be obtained. If the number average particle size thereof is equal to or smaller than 800 nm, suitable adhesion force with the organic particle may be applied, and impairing of the toner transportability may be prevented. The number average particle size thereof is more preferably from 25 nm to 600 nm, even more preferably from 30 nm to 500 nm, particularly preferably from 30 nm to 350 nm, and most preferably 30 nm to 200 nm.

In addition, when the content of the organic particle is set to w1 and the content of the inorganic particle is set to w2, w1/w2 is preferably from 0.05 to 3.0. If w1/w2 is equal to or more than 0.05, impairment of the toner transportability may be prevented. If w1/w2 is equal to or less than 3.0, the silicone oil may be efficiently applied to the surface of the photoreceptor, and evenness of the half-tone image quality may be obtained. w1/w2 is more preferably from 0.1 to 2.8, and even more preferably from 0.2 to 2.5.

In addition, as the inorganic particle, inorganic particles other than the silicone oil-treated inorganic particle may be used in combination.

The added amount of the inorganic particle is preferably from 0.3 part by weight to 6 parts by weight, more preferably from 0.4 part by weight to 5.5 parts by weight, and even more preferably from 0.6 part by weight to 5 parts by weight, with respect to 100 parts by weight of the base particle.

If the added amount of the inorganic particle is in the range described above, it is preferable since evenness of the half-tone image may be obtained.

### 1-3. Manufacturing Method of Toner and Toner Physical Property

### Toner Physical Property

The volume average particle size of the toner is preferably from 2 μm to 12 μm, and more preferably from 2.5 μm to 10 μm, and even more preferably from 3 μm to 9 μm. If the volume average particle size of the toner is in the range described above, it is preferable since stability of charge and reproducibility of dots are excellent.

In addition, in the measurement of the average particle size of the particle such as toner or the toner base particle, Coulter Multisizer II (manufactured by Beckman Coulter Inc.) may be used. In this case, the measurement may be performed using an optimal aperture depending on the particle size level of the particle. With respect to a particle size range (channel) divided based on particle size distribution, the volume and number are shown in cumulative distribution from a small diameter side, and the particle size where the accumulation of 50%, is defined as volume of D50v and the number of D50p. The volume average particle size may be obtained as D50v, and the number average particle size may be calculated as D50p.

In addition, the average circularity of the toner is preferably equal to or more than 0.930, and more preferably equal to or more than 0.940, and even more preferably equal to or more than 0.950. If the average circularity of the toner is in the range described above, it is preferable since the transfer property and a cleaning property are excellent.

The toner of the exemplary embodiment may be preferably used particularly as a positive charge toner, from charge imparting ability of the silicone oil.

### Manufacturing Method of Toner

In the exemplary embodiment, the manufacturing method of the toner is not particularly limited, and the toner may be manufactured by a well-known method.

For example, a kneading and pulverizing method of mixing components of a binder resin, a colorant, a release agent, if necessary, and a charge-controlling agent, melting and kneading the materials using a kneader or an extruder, coarse-pulverizing the obtained melted and kneaded materials, subsequently fine-pulverizing the obtained material by a jet mill, and obtaining a toner particle having a target particle size by a wind classifier; a method of changing a shape of a particle obtained by the kneading and pulverizing method by a mechanical impact force or thermal energy; emulsion aggregating method of emulsifying a binder resin, mixing the formed dispersion and dispersion of a colorant, a release agent, if necessary, and a charge-controlling agent, and performing aggregation and heating fusion to obtain a toner particle; suspension polymerization method of suspending and polymerizing a solution of a monomer for obtaining a binder resin, a colorant, and a release agent, if necessary, and a charge-controlling agent and the like in an aqueous solvent; and a dissolution suspension method of suspending and granulating a solution of a binder resin, a colorant, and a release agent, if necessary, and a charge-controlling agent and the like in an aqueous solvent are used. In addition, a manufacturing method may be used in which the toner particle obtained by the method is set as a core the aggregated particle is adhered thereto, and heating and coalescing are performed to obtain a core shell structure.

Among them, the toner of the exemplary embodiment is preferably manufactured using the kneading and pulverizing method or the emulsion aggregating method.

A method of adding the external additive to the toner base particle is not particularly limited, and a well-known method may be used. Detailed examples thereof include a method of adhering the external additive to the surface of the toner base particle with a dry system using a mixer such as a V-blender or a Henschel mixer; a method of dispersing the external additive to liquid, adding the external additive to toner in a slurry state, and performing drying for adhesion to the surface; and a method of drying while spraying the slurry to the dried toner as a wet type method.

### 2. Developer

The developer of the exemplary embodiment is a non-magnetic single-component developer containing the non-magnetic single-component toner of the exemplary embodiment, and the non-magnetic single-component toner of the exemplary embodiment may be used as the developer (non-magnetic single-component developer) as it is.

### 3. Process Cartridge, Image Forming Method, and Image Forming Apparatus

An image forming method of the exemplary embodiment includes: a latent image forming step of forming an electrostatic latent image on a surface of an image holding member; a development step of forming a developer layer on a development roll and develops the electrostatic latent image by coming in contact with the image holding member to form a toner image; a transfer step of transferring the toner image to a transfer medium; and a fixation step of fixing the toner image to the transfer medium, and the toner is the non-magnetic single-component toner of the exemplary embodiment, or the developer is the electrostatic charge image developer of the exemplary embodiment.

An image forming apparatus of the exemplary embodiment includes: an image holding member; a charging unit which charges a surface of the image holding member; an exposing unit which forms an electrostatic latent image on the charged surface of the image holding member; a development unit which develops the electrostatic latent image as a toner image by a developer including toner; a transfer unit which transfers the toner image formed on the surface of the image holding member to a surface of a transfer medium; and a fixation unit which fixes the toner image transferred to the surface of the transfer medium, and the toner is the non-magnetic single-component toner of the exemplary embodiment, or the developer is the electrostatic charge image developer of the exemplary embodiment.

Each step and each unit are typical as they are, and are disclosed in JP-A-2012-203369. In addition, the image forming method of the exemplary embodiment may be executed by using the image forming apparatus such as a well-known copier or a facsimile machine.

The latent image forming step is a step of forming an electrostatic latent image on an image holding member (photoreceptor).

The development step is a step of developing the electrostatic latent image by a developer layer on a developer holding member to form a toner image. The developer layer is not particularly limited as long as it includes the electrostatic charge image development toner of the exemplary embodiment.

The transfer step is a step of transferring the toner image onto a transfer medium. In addition, as the transfer medium of the transfer step, a recording medium such as an intermediate transfer medium or paper may be exemplified.

In the fixation step, for example, a method of fixing a toner image transferred onto a transfer sheet to form a copied image by a heating roller fixer in which a temperature of a heating roller is set to a constant temperature is used.

As the recording medium, a well-known recording medium may be used, paper used in a copier or printer of an electrophotographic system or an OHP sheet is used, for example, and a coating sheet obtained by coating a surface of a normal sheet by a resin or the like, an art sheet for printing, and the like may be suitably used.

The image forming method of the exemplary embodiment may further include a recycling step. The recycling step is a step of moving the electrostatic charge image development toner collected in the cleaning step to the developer layer. The image forming method including this recycling step is executed using an image forming apparatus such as a toner recycling system type copier or facsimile machine. In addition, the cleaning step may be omitted and a recycling system in which development is performed at the same time with collection of the toner may be applied to the image forming method.

An image forming apparatus of the exemplary embodiment preferably includes: an image holding member; a charging unit which charges the image holding member; an exposing unit which exposes the charged image holding member to form an electrostatic latent image on the image holding member; a development unit which develops the electrostatic latent image by a developer including toner to form a toner image; and a transfer unit which transfers the toner image to a transfer medium from the image holding member, and the developer including the toner preferably includes the electrostatic charge image development toner of the exemplary embodiment.

The image forming apparatus of the exemplary embodiment is not particularly limited as long as it contains at least the image holding member, the charging unit, the exposing unit, the development unit, the transfer unit, and the fixation unit described above, however, an erasing unit may be included, if necessary.

In the transfer unit, the transfer may be performed two or more times using the intermediate transfer medium. In addition, as the transfer medium of the transfer unit, a recording medium such as an intermediate transfer medium or paper may be exemplified.

The image holding member and each unit may preferably utilize the configuration described in each step of the image forming method. For all of the units, well-known units in the image forming apparatus may be used. The image forming apparatus of the exemplary embodiment may include units or devices other than the configuration described above. In addition, the image forming apparatus of the exemplary embodiment may perform plural operations of the units at the same time.

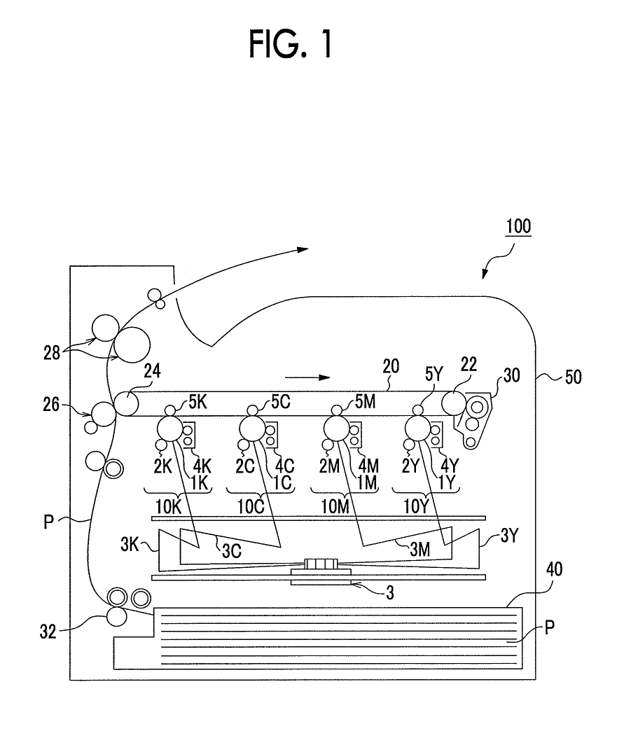

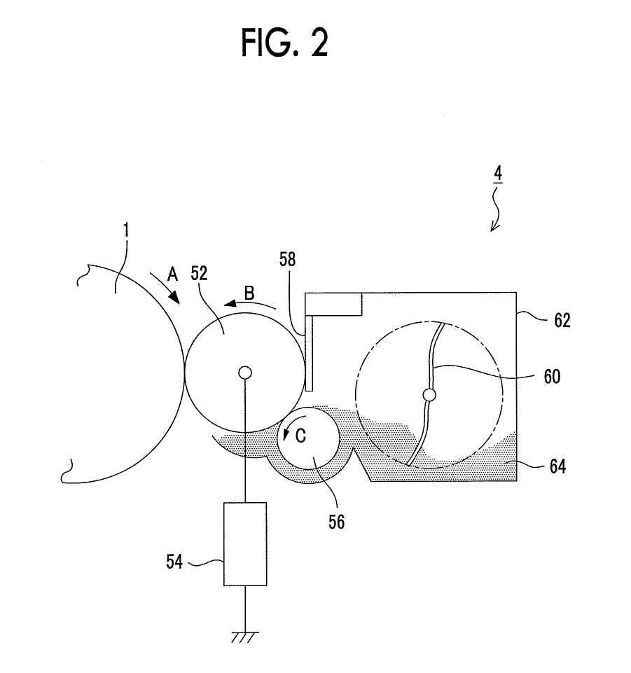

One example of the image forming apparatus which performs development using the non-magnetic single-component developer will be described hereinafter, using FIGS. 1 and 2.

FIG. 1 is a schematic view showing a configuration example of the tandem image forming apparatus for forming an image by the image forming method of the exemplary embodiment. In an image forming apparatus 100 shown in the drawing, four electrophotographic photoreceptors (image holding members) 1Y, 1M, 1C, and 1K are disposed in parallel with each other along an intermediate transfer belt 20 in a housing 50. Regarding the electrophotographic photoreceptors 1K, 1C, 1M, and 1Y, for example, the electrophotographic photoreceptor 1Y may form a yellow-colored image, the electrophotographic photoreceptor 1M may form a magenta-colored image, the electrophotographic photoreceptor 1C may form a cyan-colored image, and the electrophotographic photoreceptor 1K may form a black-colored image, respectively.

The electrophotographic photoreceptors 1Y, 1M, 1C, and 1K may be rotated in a predetermined direction (counterclockwise rotation on a paper surface), and charging rolls 2Y, 2M, 2C, and 2K, developing devices 4Y, 4M, 4C, and 4K, primary transfer rolls 5Y, 5M, 5C, and 5K are disposed along the rotation direction. In this case, each of the electrophotographic photoreceptors and the developing devices are configured to be mounted as the same unit, that is, a process cartridge. The primary transfer rolls 5Y, 5M, 5C, and 5K come in contact with the electrophotographic photoreceptors 1Y, 1M, 1C, and 1K, respectively, through the intermediate transfer belt 20.

In addition, an exposing device 3 is disposed in a predetermined position in the housing 50, and a light beam which is emitted from the exposing device 3 may be applied to the surface of the electrophotographic photoreceptors 1Y, 1M, 1C, and 1K after charging. Accordingly, in the rotation step of the electrophotographic photoreceptors 1Y, 1M, 1C, and 1K, each step of charging, exposing, developing and primary transfer is sequentially performed, and toner images of each color are transferred on the intermediate transfer belt 20 in an overlapped manner.

Herein, the charging rolls 2Y, 2M, 2C, and 2K apply voltage to the photoreceptors by contact of conductive members (charging rolls) with the surfaces of the electrophotographic photoreceptors 1Y, 1M, 1C, and 1K, and charge the surfaces of the photoreceptors to a predetermined potential (charging step). Other than the charging rolls shown in the exemplary embodiment, the charging performed by the contact charging system may be performed by using a charging brush, a charging film, or a charging tube. In addition, the charging may be performed by a non-contact method using a corotron or a scorotron.

As the exposing device 3, an optical device or the like which may expose the surfaces of the electrophotographic photoreceptors 1Y, 1M, 1C, and 1K with a light source such as a semiconductor laser, a light emitting diode (LED), a liquid crystal shutter, in a desired image shape, may be used.

As the development devices 4Y, 4M, 4C, and 4K, a general development device which performs development by contacting with non-magnetic single-component toner or non-magnetic single-component developer, which will be described later, may be used (development step). Such a development device is not particularly limited as long as the non-magnetic single-component toner or the non-magnetic single-component developer is used, and a well-known development device may be suitably selected according to the object. In the primary transfer step, toner of each color is sequentially subjected to primary transfer to the intermediate transfer belt 20 from the image holding member, by applying primary transfer bias having reverse polarity to the toner on the image holding member to the primary transfer rolls 5Y, 5M, 5C, 5K.

The intermediate transfer belt 20 is supported with predetermined tension by a driving roll 22 and a backup roll 24, and may be rotated without generating deflection by the rotation of these rolls. In addition, a secondary transfer roll 26 is disposed to come in contact with the backup roll 24 through the intermediate transfer belt 20.

The toner is subjected to secondary transfer to a recording medium P from the intermediate transfer belt 20, by applying secondary transfer bias having reverse polarity to the toner on the intermediate transfer belt 20 to the secondary transfer roll 26. The surface of the intermediate transfer belt 20 which passes through between the backup roll 24 and the secondary transfer roll 26 is cleaned by, for example, a cleaning unit 30 including a cleaning blade disposed in the vicinity of the driving roll 22, or an erasing device (not shown), and then the intermediate transfer belt is repeatedly provided for the next image forming process. A tray (recording medium tray) 40 is disposed in a predetermined position of the housing 50, and the recording medium P such as paper in the tray 40 is sequentially transported between the intermediate transfer belt 20 and the secondary transfer roll 26 by a transportation roll 32, and also between two fixing rolls 28 which comes in contact with each other, and then is discharged to the outside of the housing 50.

Next, the development device will be described.

As shown in FIG. 2, the development device 4 is configured from a development roll 52 which is disposed so as to come in contact with an image holding member 1 capable of rotating in an arrow A direction by a driving source (not shown) and may be driven to be rotated in an arrow B direction along the rotation of the image holding member (photoreceptor) 1, a bias power supply 54 which is connected to the development roll 52, a toner scraping member 56 which is disposed so as to press the development roll 52 in a downstream position of a contact portion of the development roll 52 and the image holding member 1 in the rotation direction of the development roll 52, and may be rotated in an arrow C direction so as to move backward with respect to the rotation of the development roll 52, a toner layer regulation member 58 which is disposed so as to come in contact the development roll 52 in a downstream position of the nip portion of the development roll 52 and the toner scraping member 56 and an upstream position of the contact portion of the development roll 52 and the image holding member 1, in the rotation direction of the development roll 52, an enclosure 62 which is positioned on a side opposite to the side where the image holding member 1 of the development roll 52 is disposed and includes an opening portion to a side where the development roll 52 is disposed, and an agitator 60 which is disposed in the enclosure 62.

One end of the toner layer regulation member 58 is fixed to the opening portion of the enclosure 62, so as to close the opening portion of the enclosure 62. The side (lower side of the opening portion) opposite to the side (upper side of the opening portion) where the toner layer regulation member 58 is attached to the opening portion of the enclosure 62, is configured so as to cover the lower side of the development roll 52 or the toner scraping member 56. Herein, toner (non-magnetic single-component developer) 64 is disposed so as to be accumulated on the lower side of the enclosure 62, and is accumulated so as to fill a space between the lower side of the development roll 52 and the lower side of the opening portion of the enclosure 62 without any space and to cover the toner scraping member 56. In addition, the toner 64 is set to be suitably supplied to the opening portion side of the enclosure 62 where the development roll 52 is disposed, from the enclosure 62 by the agitator 60 which is provided in the enclosure 62.

At the time of development, first, the toner 64 in the enclosure 62 is supplied to the surface of the development roll 52 by the toner scraping member 56 from the agitator 60. Next, the toner 64 adhered to the surface of the development roll 52 is adhered to the surface of the development roll 52 so as to form a toner layer with an even thickness by the toner layer regulation member 58. Then, according to the potential difference between the surface of the image holding member 1 where an electrostatic latent image (not shown) is formed and the development roll 52 to which bias voltage is applied by the bias power supply 54, the toner 64 which is adhered to the surface of the development roll 52 is transferred to the image holding member 1 and an electrostatic latent image is developed. In addition, the toner 64 remaining on the surface of the development roll 52 after finishing the development is scraped by the toner scraping member 56.

As the toner layer regulation member 58, a well-known metal blade or elastic blade is exemplified, and as the development roll, a well-known metal roll or elastic roll is exemplified.

In the exemplary embodiment, as shown in FIG. 2, the image holding member and the development roll preferably come in contact with each other while rotating in a forward direction. By coming in contact with each other while rotating in the forward direction, the contact time may be set longer.

At that time, a relative rate of the development roll with respect to the image holding member is preferably from 1.1 times to 2.5 times. That is, when the rotation rate of the image holding member is set to 1, the rotation rate of the development roll is preferably from 1.1 to 2.5. Setting the rotation rate of the development roll faster than the rotation rate of the image holding member is preferable since the development amount (amount of the non-magnetic single-component toner which moves to the photoreceptor) may be increased.

The relative rate of the development roll with respect to the image holding member is preferably from 1.1 times to 2.5 times, more preferably from 1.2 times to 2.2 times, and even more preferably from 1.3 times to 2.0 times.

In addition, in the exemplary embodiment, it is preferable to further include a cleaning step of collecting the toner not transferred of the image holding member to the development device through the development roll. Described with reference to FIG. 2, the toner not transferred (not shown) that is remaining in the image holding member 1 after the transfer step in the exemplary embodiment is preferably moved to the development roll 52 to be collected to the development device 4 by the contact of the image holding member 1 and the development roll 52. Accordingly, the toner not transferred of the image holding member is cleaned without separately providing a cleaning unit or cleaning step of the image holding member.

In the exemplary embodiment, the image forming apparatus preferably includes a process cartridge. That is, each of the electrophotographic photoreceptors and the development devices are preferably configured so as to be mounted as a process cartridge.

The process cartridge of the exemplary embodiment is detachable from an image forming apparatus, accommodates the electrostatic charge image developer (non-magnetic single-component developer) of the exemplary embodiment, and includes a development unit which develops an electrostatic latent image formed on a surface of an image holding member by the electrostatic charge image developer to form a toner image.

### EXAMPLES

Hereinafter, the exemplary embodiments will be further described with reference to Examples, however the exemplary embodiments are not limited to Examples.

### Example 1

### Preparation of Silicone Oil-Treated Inorganic Particle 1

10 parts of alkyl-modified silicone oil (KF-414, manufactured by Shin-Etsu Chemical Co., Ltd.) is sprayed to 100 parts of silica particles (number average particle size of 120 nm) prepared by a gas phase method, by spray drying, and surface treatment of the silica particles is performed. The surface-treated silica particles are crushed, and a silicone oil-treated inorganic particle 1 is obtained.

### Preparation of Organic Particle 1

Glycerin monostearate (Rikemar S-100, manufactured by Riken Vitamin Co., Ltd.) is pulverized by a ball mill, is sieved by a mesh to remove coarse particles, and an organic particle 1 having a number average particle size of 4.5 μm is obtained.

### Preparation of Amorphous Polyester Resin 1

Bisphenol A ethylene oxide 2 moles adduct: 10 mol %

Bisphenol A propylene oxide 2 moles adduct: 40 mol %

Terephthalic acid: 50 mol %

A monomer with the above composition ratio is put into a flask including a stirrer, a nitrogen inlet tube, a temperature sensor, and a rectifier, the temperature is increased up to 190° C. over 1 hour, and after confirming the stirring is performed with no variation in a reaction system, 1.0% by weight of dibutyltin oxide is added. Further, while distilling away generated water, the temperature is increased from the same temperature up to 240° C. over 6 hours, dehydration condensation reaction is further continued for 2.5 hours at 240° C., and an amorphous polyester resin 1 having a glass transition temperature of 62° C. and an weight-average molecular weight (Mw) of 35,000 is obtained.

### Preparation of Crystalline Polyester Resin 1

50 mol % of sebacic acid, 50 mol of 1,6-hexanediol, and 0.3% by weight of dibutyltin oxide are mixed in a flask, heated to 240° C. under a reduced-pressure atmosphere, the dehydration condensation is performed for 6 hours, and a crystalline polyester resin 1 is obtained. The endothermic peak temperature (melting temperature) of the obtained crystalline polyester resin 1 is 70° C. In addition, the endothermic peak is measured using DSC-60A (manufactured by Shimadzu Corporation).

### Preparation of Toner 1

### Preparation of Toner Base Particle 1

| | | |
|---|---|---|
| Amorphous polyester resin 1 | 71 | parts |
| Crystalline polyester resin 1 | 15 | parts |
| Carbon black (product name: #25B manufactured by | 6 | parts |
| Mitsubishi Chemical Corporation) | | |
| Charge-controlling agent (product name: BONTRON N-01, | 2 | parts |
| manufactured by Orient Chemical Industries Co., Ltd.) | | |
| Paraffin wax (product name: HNP9 manufactured by NIPPON | 6 | parts |
| SEIRO CO., LTD.) | | |

The compositions described above are powder-mixed by a Henschel mixer, this is heat-kneaded by an extruder having a set temperature of 100° C., and cooled, and then, coarse pulverizing, fine pulverizing, and classification are performed.

Air heating treatment is performed with a thermal shaping device “Surfusing System SFS-3 type” (manufactured by Nippon Pneumatic Mfg. Co., Ltd.), and a toner base particle 1 having a volume average particle size D50 of 6.8 μm is obtained.

### Preparation of Toner 1

| | |
|---|---|
| Toner base particle 1 | 100 parts |
| Silica particle (product name: RA200H manufactured by | 0.6 part |
| NIPPON AEROSIL CO., LTD) | |
| Silicone oil-treated inorganic particle 1 | 1.5 parts |
| Organic particle 1 | 1.0 part |

The compositions described above are mixed in the Henschel mixer, and toner 1 is obtained.

### Evaluation Method

The evaluation is performed using DocuPrint P300d manufactured by Fuji Xerox Company, Limited, which employed a non-magnetic single-component contact development method and a development with simultaneous cleaning method with alteration of circumferential speed of the toner carrier to be variable.

By setting the environment of the altered device to a low-humidity environment with a temperature of 20° C. and humidity of 20%, 5,000 A4-sized images having image density of 0.2% are continuously printed. Further, 500 A4-sized images in a stripe shape are printed with respect to the proceeding direction of the paper, and immediately after the printing of 500 sheets, the half-tone image (image density of 30%) of the entire surface is further printed. In Examples 1 to 31 and Comparative Examples 1 to 6, the relative rate of the development roll with respect to the image holding member is 1.8 times. The evaluation is executed in the same manner as Example 1 except for changing the relative rate of the development roll with respect to the image holding member to 1.1 times in Example 32, which will be described later, to 2.5 times in Example 33, to 1.0 times in Example 34, and to 2.6 times in Example 35, respectively.

Half-tone images at that time are visually observed and the evenness of the images are determined with the following criteria.

A: No stripe history is recognized, and image evenness is extremely excellent.

B: Extremely slight stripe history is recognized, however it is in a sufficiently acceptable level, and image evenness is excellent.

C: Slight stripe history is recognized however it is in an acceptable level.

D: Stripe history is clearly recognized visually and there is an image evenness problem.

### Examples 2 to 31 and Comparative Examples 1 to 6

### Preparation of Organic Particle

### Preparation of Organic Particle 2

Stearic acid amide (fatty acid amide T manufactured by Kao Corporation) is pulverized by a ball mill, is sieved by a mesh to remove coarse particles, and an organic particle 2 having a number average particle size of 5.4 μm is obtained.

### Preparation of Organic Particle 3

Higher fatty acid having behenic acid as a main component (LUNAC BA manufactured by Kao Corporation) is pulverized by a ball mill, is sieved by a mesh to remove coarse particles, and an organic particle 3 having a number average particle size of 6.2 μm is obtained.

### Preparation of Organic Particle 4

Stearyl alcohol (KALCOL 8098 manufactured by Kao Corporation) is pulverized by a ball mill, is sieved by a mesh to remove coarse particles, and an organic particle 4 having a number average particle size of 5.1 μm is obtained.

### Preparation of Organic Particle 5

Montanic acid ester (Licowax E manufactured by Clariant Japan K.K.) is pulverized by a jet mill, is sieved by a mesh to remove coarse particles, and an organic particle 5 having a number average particle size of 10.2 μm is obtained.

### Preparation of Organic Particle 6

Stearyl stearate (Rikemar SL-900, manufactured by Riken Vitamin Co., Ltd.) is pulverized by a jet mill, is sieved by a mesh to remove coarse particles, and an organic particle 6 having a number average particle size of 8.9 μm is obtained.

### Preparation of Organic Particle 7

Palmitic acid amide (DIAMID KP manufactured by Nippon Kasei Chemical Co., Ltd.) is pulverized by a ball mill, is subjected to air heating treatment, and then is sieved by a mesh to remove coarse particles, and an organic particle 7 having a number average particle size of 5.1 μm is obtained.

### Preparation of Organic Particle 8

Lauric acid amide (DIAMID Y manufactured by Nippon Kasei Chemical Co., Ltd.) is pulverized by a ball mill, is subjected to air heating treatment, and then is sieved by a mesh to remove coarse particles, and an organic particle 8 having a number average particle size of 4.9 μm is obtained.

### Preparation of Organic Particle 9

The organic particle 1 is sieved by a mesh and an organic particle 9 having a number average particle size of 0.4 μm is obtained.

### Preparation of Organic Particle 10

The organic particle 1 is sieved by a mesh and an organic particle 10 having a number average particle size of 0.7 μm is obtained.

### Preparation of Organic Particle 11

In preparation of the organic particle 2, the rotation time of the ball mill is adjusted and an organic particle 11 having a number average particle size of 14.6 μm is obtained.

### Preparation of Organic Particle 12

In preparation of the organic particle 2, the rotation time of the ball mill is adjusted and an organic particle 12 having a number average particle size of 15.2 μm is obtained.

### Preparation of Organic Particle 13

Polyethylene (Neowax ACL manufactured by Yasuhara Chemical Co., Ltd.) is pulverized by a ball mill, is sieved by a mesh to remove coarse particles, and an organic particle 13 having a number average particle size of 6.4 μm is obtained.

### Preparation of Silicone Oil-Treated Inorganic Particle

### Preparation of Silicone Oil-Treated Inorganic Particle 2

4 parts of alkyl-modified silicone oil (KF-414, manufactured by Shin-Etsu Chemical Co., Ltd.) is sprayed to 100 parts of silica particles (number average particle size of 200 nm) prepared by a sol-gel method, by spray drying, and surface treatment of the silica particles is performed. The surface-treated silica particles are crushed, and a silicone oil-treated inorganic particle 2 is obtained.

### Preparation of Silicone Oil-Treated Inorganic Particle 3

5 parts of alkyl-modified silicone oil (KF-414, manufactured by Shin-Etsu Chemical Co., Ltd.) is sprayed to 100 parts of silica particles (number average particle size of 180 nm) prepared by a sol-gel method, by spray drying, and surface treatment of the silica particles is performed. The surface-treated silica particles are crushed, and a silicone oil-treated inorganic particle 3 is obtained.

### Preparation of Silicone Oil-Treated Inorganic Particle 4

25 parts of alkyl-modified silicone oil (KF-414, manufactured by Shin-Etsu Chemical Co., Ltd.) is sprayed to 100 parts of silica particles (number average particle size of 65 nm) prepared by a gas phase method, by spray drying, and surface treatment of the silica particles is performed. The surface-treated silica particles are crushed, and a silicone oil-treated inorganic particle 4 is obtained.

### Preparation of Silicone Oil-Treated Inorganic Particle 5

30 parts of alkyl-modified silicone oil (KF-414, manufactured by Shin-Etsu Chemical Co., Ltd.) is sprayed to 100 parts of silica particles (number average particle size of 55 nm) prepared by a gas phase method, by spray drying, and surface treatment of the silica particles is performed. The surface-treated silica particles are crushed, and a silicone oil-treated inorganic particle 5 is obtained.

### Preparation of Silicone Oil-Treated Inorganic Particle 6

8 parts of dimethyl silicone oil (KF-96-200cs, manufactured by Shin-Etsu Chemical Co., Ltd.) is sprayed to 100 parts of silica particles (number average particle size of 150 nm) prepared by a sol-gel method, by spray drying, and surface treatment of the silica particles is performed. The surface-treated silica particles are crushed, and a silicone oil-treated inorganic particle 6 is obtained.

### Preparation of Silicone Oil-Treated Inorganic Particle 7

20 parts of dimethyl silicone oil (KF-96-300cs, manufactured by Shin-Etsu Chemical Co., Ltd.) is sprayed to 100 parts of silica particles (number average particle size of 80 nm) prepared by a gas phase method, by spray drying, and surface treatment of the silica particles is performed. The surface-treated silica particles are crushed, and a silicone oil-treated inorganic particle 7 is obtained.

### Preparation of Hexamethyldisilazane (HMDS)-Treated Inorganic Particle 1

10 parts of hexamethyldisilazane (SZ-31, manufactured by Shin-Etsu Chemical Co., Ltd.) is sprayed to 100 parts of silica particles (number average particle size of 120 nm) prepared by a gas phase method, by spray drying, and surface treatment of the silica particles is performed. The surface-treated silica particles are crushed, and a hexamethyldisilazane-treated inorganic particle 1 is obtained.

### Preparation of Crystalline Polyester Resin

### Preparation of Crystalline Polyester Resin 2

50 mol % of adipic acid, 50 mol % of 1,6-hexanediol, and 0.3% by weight of dibutyltin oxide are mixed in a flask, heated to 240° C. under a reduced-pressure atmosphere, the dehydration condensation is performed for 6 hours, and a crystalline polyester resin 2 is obtained. The endothermic peak temperature of the obtained crystalline polyester resin 2 is 53° C.

### Preparation of Crystalline Polyester Resin 3

50 mol % of tetradecanedioic acid, 50 mol % of 1,20-icosanediol, and 0.3% by weight of dibutyltin oxide are mixed in a flask, heated to 240° C. under a reduced-pressure atmosphere, the dehydration condensation is performed for 6 hours, and a crystalline polyester resin 3 is obtained. The endothermic peak temperature of the obtained crystalline polyester resin 3 is 98° C.

### Preparation of Crystalline Polyester Resin 4

50 mol % of suberic acid, 50 mol % of 1,4-butanediol, and 0.3% by weight of dibutyltin oxide are mixed in a flask, heated to 240° C. under a reduced-pressure atmosphere, the dehydration condensation is performed for 6 hours, and a crystalline polyester resin 4 is obtained. The endothermic peak temperature of the obtained crystalline polyester resin 4 is 47° C.

### Preparation of Crystalline Polyester Resin 5

50 mol % of icosane diacid, 50 mol % of 1,20-icosanediol, and 0.3% by weight of dibutyltin oxide are mixed in a flask, heated to 240° C. under a reduced-pressure atmosphere, the dehydration condensation is performed for 6 hours, and a crystalline polyester resin 5 is obtained. The endothermic peak temperature of the obtained crystalline polyester resin 5 is 105° C.

### Preparation of Toner

### Preparation of Toner 2

Toner 2 is obtained in the same manner as in the preparation of the toner 1, except for changing the organic particle 1 to the organic particle 2.

### Preparation of Toner 3

Toner 3 is obtained in the same manner as in the preparation of the toner 1, except for changing the organic particle 1 to the organic particle 3.

### Preparation of Toner 4

Toner 4 is obtained in the same manner as in the preparation of the toner 1, except for changing the organic particle 1 to the organic particle 4.

### Preparation of Toner 5

### Preparation of Toner Base Particle 2

| | |
|---|---|
| Amorphous polyester resin 1 | 75 parts |
| Crystalline polyester resin 2 | 11 parts |
| Carbon black (product name: #25B manufactured by | 6 parts |
| Mitsubishi Chemical Corporation) | |
| Charge-controlling agent (produce name: BONTRON N-01, | 2 parts |
| manufactured by Orient Chemical Industries Co., Ltd.) | |
| Paraffin wax (product name: HNP9 manufactured by NIPPON | 6 parts |
| SEIRO CO., LTD.) | |

The compositions described above are powder-mixed by a Henschel mixer, this is heat-kneaded by an extruder having a set temperature of 100° C., and cooled, and then, coarse pulverizing, fine pulverizing, and classification are performed.

Air heating treatment is performed with a thermal shaping device “Surfusing System SFS-3 type” (manufactured by Nippon Pneumatic Mfg. Co., Ltd.), and a toner base particle 2 having a volume average particle size D50 of 6.5 μm is obtained.

### Preparation of Toner 5

| | |
|---|---|
| Toner base particle 2 | 100 parts |
| Silica particle (product name: RA200H manufactured by | 0.6 part |
| NIPPON AEROSIL CO., LTD) | |
| Silicone oil-treated inorganic particle 1 | 1.5 parts |
| Organic particle 1 | 1.0 part |

The compositions described above are mixed in the Henschel mixer, and toner 5 is obtained.

### Preparation of Toner 6

### Preparation of Toner Base Particle 3

| | |
|---|---|
| Amorphous polyester resin 1 | 73 parts |
| Crystalline polyester resin 3 | 13 parts |
| Carbon black (product name: #25B manufactured by | 6 parts |
| Mitsubishi Chemical Corporation) | |
| Charge-controlling agent (product name: BONTRON N-01, | 2 parts |
| manufactured by Orient Chemical Industries Co., Ltd.) | |
| Paraffin wax (product name: HNP9 manufactured by NIPPON | 6 parts |
| SEIRO CO., LTD.) | |

The compositions described above are powder-mixed by a Henschel mixer, this is heat-kneaded by an extruder having a set temperature of 100° C., and cooled, and then, coarse pulverizing, fine pulverizing, and classification are performed.

Air heating treatment is performed with a thermal shaping device “Surfusing System SFS-3 type” (manufactured by Nippon Pneumatic Mfg. Co., Ltd.), and a toner base particle 3 having a volume average particle size D50 of 7.1 μm is obtained.

### Preparation of Toner 6

| | |
|---|---|
| Toner base particle 3 | 100 parts |
| Silica particle (product name: RA200H manufactured by | 0.6 part |
| NIPPON AEROSIL CO., LTD) | |
| Silicone oil-treated inorganic particle 1 | 1.5 parts |
| Organic particle 1 | 1.0 part |

The compositions described above are mixed in the Henschel mixer, and toner 6 is obtained.

### Preparation of Toner 7

Toner 7 is obtained in the same manner as in the preparation of toner 1, except for changing the organic particle 1 to the organic particle 5.

### Preparation of Toner 8

Toner 8 is obtained in the same manner as in the preparation of toner 1, except for changing the organic particle 1 to the organic particle 6.

### Preparation of Toner 9

Toner 9 is obtained in the same manner as in the preparation of toner 1, except for changing the organic particle 1 to the organic particle 7.

### Preparation of Toner 10

Toner 10 is obtained in the same manner as in the preparation of toner 1, except for changing the organic particle 1 to the organic particle 8.

### Preparation of Toner 11

Toner 11 is obtained in the same manner as in the preparation of toner 1, except for changing the organic particle 1 to the organic particle 9.

### Preparation of Toner 12

Toner 12 is obtained in the same manner as in the preparation of toner 1, except for changing the organic particle 1 to the organic particle 10.

### Preparation of Toner 13

Toner 13 is obtained in the same manner as in the preparation of toner 1, except for changing the organic particle 1 to the organic particle 11.

### Preparation of Toner 14

Toner 14 is obtained in the same manner as in the preparation of toner 1, except for changing the organic particle 1 to the organic particle 12.

### Preparation of Toner 15

Toner 15 is obtained in the same manner as in the preparation of toner 1, except for changing the silicone oil-treated inorganic particle 1 to the silicone oil-treated inorganic particle 2.

### Preparation of Toner 16

Toner 16 is obtained in the same manner as in the preparation of toner 1, except for changing the silicone oil-treated inorganic particle 1 to the silicone oil-treated inorganic particle 3.

### Preparation of Toner 17

Toner 17 is obtained in the same manner as in the preparation of toner 1, except for changing the silicone oil-treated inorganic particle 1 to the silicone oil-treated inorganic particle 4.

### Preparation of Toner 18

Toner 18 is obtained in the same manner as in the preparation of toner 1, except for changing the silicone oil-treated inorganic particle 1 to the silicone oil-treated inorganic particle 5.

### Preparation of Toner 19

| | |
|---|---|
| Toner base particle 1 | 100 parts |
| Silica particle (product name: RA200H manufactured by | 0.6 part |
| NIPPON AEROSIL CO., LTD) | |
| Silicone oil-treated inorganic particle 6 | 4.5 parts |
| Organic particle 1 | 0.2 part |

The compositions described above are mixed in the Henschel mixer, and toner 19 is obtained.

### Preparation of Toner 20

| | |
|---|---|
| Toner base particle 1 | 100 parts |
| Silica particle (product name: RA200H manufactured by | 0.6 part |
| NIPPON AEROSIL CO., LTD) | |
| Silicone oil-treated inorganic particle 6 | 5.0 parts |
| Organic particle 1 | 0.3 part |

The compositions described above are mixed in the Henschel mixer, and toner 20 is obtained.

### Preparation of Toner 21

| | |
|---|---|
| Toner base particle 1 | 100 parts |
| Silica particle (product name: RA200H manufactured by | 0.6 part |
| NIPPON AEROSIL CO., LTD) | |
| Silicone oil-treated inorganic particle 7 | 0.5 part |
| Organic particle 1 | 1.7 parts |

The compositions described above are mixed in the Henschel mixer, and toner 21 is obtained.

### Preparation of Toner 22

| | |
|---|---|
| Toner base particle 1 | 100 parts |
| Silica particle (product name: RA200H manufactured by | 0.6 part |
| NIPPON AEROSIL CO., LTD) | |
| Silicone oil-treated inorganic particle 7 | 0.8 part |
| Organic particle 1 | 2.3 parts |

The compositions described above are mixed in the Henschel mixer, and toner 22 is obtained.

### Preparation of Toner 23

| | |
|---|---|
| Toner base particle 1 | 100 parts |
| Silica particle (product name: RA200H manufactured by | 0.6 part |
| NIPPON AEROSIL CO., LTD) | |
| Silicone oil-treated inorganic particle 1 | 0.6 part |
| Organic particle 2 | 0.08 part |

The compositions described above are mixed in the Henschel mixer, and toner 23 is obtained.

### Preparation of Toner 24

| | |
|---|---|
| Toner base particle 1 | 100 parts |
| Silica particle (product name: RA200H manufactured by | 0.6 part |
| NIPPON AEROSIL CO., LTD) | |
| Silicone oil-treated inorganic particle 1 | 0.6 part |
| Organic particle 2 | 0.15 part |

The compositions described above are mixed in the Henschel mixer, and toner 24 is obtained.

### Preparation of Toner 25

| | |
|---|---|
| Toner base particle 1 | 100 parts |
| Silica particle (product name: RA200H manufactured by | 0.6 part |
| NIPPON AEROSIL CO., LTD) | |
| Silicone oil-treated inorganic particle 1 | 3.0 parts |
| Organic particle 2 | 4.8 parts |

The compositions described above are mixed in the Henschel mixer, and toner 25 is obtained.

### Preparation of Toner 26

| | |
|---|---|
| Toner base particle 1 | 100 parts |
| Silica particle (product name: RA200H manufactured by | 0.6 part |
| NIPPON AEROSIL CO., LTD) | |
| Silicone oil-treated inorganic particle 1 | 3.4 parts |
| Organic particle 2 | 5.2 parts |

The compositions described above are mixed in the Henschel mixer, and toner 26 is obtained.

### Preparation of Toner 27

| | |
|---|---|
| Toner base particle 1 | 100 parts |
| Silica particle (product name: RA200H manufactured by | 0.6 part |
| NIPPON AEROSIL CO., LTD) | |
| Silicone oil-treated inorganic particle 1 | 0.25 part |
| Organic particle 1 | 0.45 part |

The compositions described above are mixed in the Henschel mixer, and toner 27 is obtained.

### Preparation of Toner 28

| | |
|---|---|
| Toner base particle 1 | 100 parts |
| Silica particle (product name: RA200H manufactured by | 0.6 part |
| NIPPON AEROSIL CO., LTD) | |
| Silicone oil-treated inorganic particle 1 | 0.35 part |
| Organic particle 1 | 0.6 part |

The compositions described above are mixed in the Henschel mixer, and toner 28 is obtained.

### Preparation of Toner 29

| | | |
|---|---|---|
| Toner base particle 1 | 100 | parts |
| Silica particle (product name: RA200H manufactured by | 0.6 | part |
| NIPPON AEROSIL CO., LTD) | | |
| Silicone oil-treated inorganic particle 1 | 5.8 | parts |
| Organic particle 1 | 2.2 | parts |

The compositions described above are mixed in the Henschel mixer, and toner 29 is obtained.

### Preparation of Toner 30

| | | |
|---|---|---|
| Toner base particle 1 | 100 | parts |
| Silica particle (product name: RA200H manufactured by | 0.6 | part |
| NIPPON AEROSIL CO., LTD) | | |
| Silicone oil-treated inorganic particle 1 | 6.3 | parts |
| Organic particle 1 | 2.4 | parts |

The compositions described above are mixed in the Henschel mixer, and toner 30 is obtained.

### Preparation of Toner 31

### Preparation of Crystalline Polyester Resin Particle Dispersion 1

| | |
|---|---|
| Crystalline polyester 1 | 50 parts |
| Anionic surfactant (NEOGEN SC manufactured by DAI-ICHI | 2 parts |
| KOGYO SEIYAKU CO., LTD.) | |
| Ion-exchange water | 200 parts |

The components are heated to 120° C., are sufficiently dispersed with ULTRA-TURRAX T50 manufactured by IKAWORKS, Inc., and then are subjected to dispersion treatment by a pressure discharging type homogenizer, and are collected when a volume average particle size is 180 nm. In doing so, crystalline polyester resin particle dispersion 1 having solid content of 20% by weight is obtained.

### Preparation of Amorphous Polyester Resin Particle Dispersion 1

The amorphous polyester resin 1 is set in a molten state and is transported to CAVITRON CD1010 (manufactured by EUROTEC LTD.) at a speed of 100 g per minute. Diluted ammonia water having concentration of 0.37% by weight obtained by diluting reagent ammonia water with ion-exchange water is input to a separately-prepared aqueous medium tank, and while heating to 120° C. by a heat exchanger, is transported to the CAVITRON at the same time with the polyester resin melt at a speed of 0.1 liter per minute. The CAVITRON is driven with conditions where the rotation rate of the rotator is 60 Hz and the pressure is 5 kg/cm², and amorphous polyester resin particle dispersion 1 having a volume average particle size of 160 nm and solid content of 20% by weight is obtained.

### Preparation of Colorant Particle Dispersion

| | |
|---|---|
| Carbon black (product name: #25B manufactured by | 20 parts |
| Mitsubishi Chemical Corporation) | |
| Anionic surfactant (NEOGEN SC manufactured by DAI-ICHI | 2 parts |
| KOGYO SEIYAKU CO., LTD.) | |
| Ion-exchange water | 80 parts |

The components described above are mixed and are dispersed by high-pressure impact type disperser ultimizer (HJP30006 manufactured by Sugino Machine Limited) for 1 hour, and colorant particle dispersion having a volume average particle size of 180 nm and solid content of 20% by weight is obtained.

### Preparation of Release Agent Dispersion

| | |
|---|---|
| Paraffin wax (product name: HNP9 manufactured by NIPPON | 20 parts |
| SEIRO CO., LTD.) | |
| Anionic surfactant (NEOGEN SC manufactured by DAI-ICHI | 2 parts |
| KOGYO SEIYAKU CO., LTD.) | |
| Ion-exchange water | 80 parts |

The components described above are mixed, are heated to 100° C., are sufficiently dispersed with ULTRA-TURRAX T50 manufactured by IKA WORKS, Inc., and then are subjected to dispersion treatment by a pressure discharging type gaulin homogenizer, and release agent dispersion having a volume average particle size of 200 nm and solid content of 20% by weight is obtained.

### Preparation of Charge-Controlling Agent Particle Dispersion

| | |
|---|---|
| Charge-controlling agent (product name: BONTRON N-01, | 20 parts |
| manufactured by Orient Chemical Industries Co., Ltd.) | |
| Anionic surfactant (NEOGEN SC manufactured by DAI-ICHI | 2 parts |
| KOGYO SEIYAKU CO., LTD.) | |
| Ion-exchange water | 80 parts |

The components are heated to 120° C., are sufficiently dispersed with ULTRA-TURRAX T50 manufactured by IKA WORKS, Inc., and then are subjected to dispersion treatment by a pressure discharging type homogenizer, and are collected when a volume average particle size is 180 nm. In doing so, charge-controlling agent particle dispersion having solid content of 20% by weight is obtained.

### Preparation of Toner Base Particle 4

| | |
|---|---|
| Crystalline polyester resin particle dispersion 1 | 15 parts |
| Amorphous polyester resin particle dispersion 1 | 50 parts |
| Colorant particle dispersion | 6 parts |
| Release agent dispersion | 6 parts |
| Charge-controlling agent particle dispersion | 2 parts |
| Ion-exchange water | 80 parts |

The above components are input into a round stainless steel flask, and are sufficiently mixed and dispersed with ULTRA-TURRAX T50. Then, 0.4 parts of polyaluminum chloride is added thereto, and the dispersion operation is continued with ULTRA-TURRAX. Further, while stirring the flask, the components are heated up to 57° C. by an oil bath for heating. After holding at 57° C. for 3 hours, 20 parts of the amorphous polyester resin particle dispersion 1 is gently added thereto.

After that, pH in the system is set to 8.5 by 0.5 N sodium hydroxide aqueous solution, and then the stainless steel flask is sealed, heated up to 90° C. while stirring by using magnetic seal, and held for 3 hours.

After finishing the reaction, cooling, filtering, and sufficient washing by the ion-exchange water are performed, and then solid-liquid separation is performed by a Nutsche type suction filtration. Then, vacuum drying is performed for 12 hours, and a toner base particle 4 having a volume average particle size D50 of 5.6 μm is obtained.

### Preparation of Toner 31

| | | |
|---|---|---|
| Toner base particle 4 | 100 | parts |
| Silica particle (product name: RA200H manufactured by | 0.6 | part |
| NIPPON AEROSIL CO., LTD) | | |
| Silicone oil-treated inorganic particle 1 | 1.2 | parts |
| Organic particle 1 | 1.1 | parts |

The compositions described above are mixed by the Henschel mixer, and toner 31 is obtained.

### Preparation of Toner 32

| | | |
|---|---|---|
| Toner base particle 1 | 100 | parts |
| Silica particle (product name: RA200H manufactured by | 0.6 | part |
| NIPPON AEROSIL CO., LTD) | | |
| Silicone oil-treated inorganic particle 1 | 1.5 | parts |

The compositions described above are mixed by the Henschel mixer, and toner 32 is obtained.

### Preparation of Toner 33

Toner 33 is obtained in the same manner as in the preparation of the toner 1, except for changing the organic particle 1 to the organic particle 13.

### Preparation of Toner 34

| | | |
|---|---|---|
| Toner base particle 1 | 100 | parts |
| Silica particle (product name: RA200H manufactured by | 0.6 | part |
| NIPPON AEROSIL CO., LTD) | | |
| Organic particle 1 | 1.0 | part |

The compositions described above are mixed in the Henschel mixer, and toner 34 is obtained.

### Preparation of Toner 35

Toner 35 is obtained in the same manner as in the preparation of the toner 1, except for changing the silicone oil-treated inorganic particle 1 to the hexamethyldisilazane-treated inorganic particle 1.

### Preparation of Toner 36

### Preparation of Toner Base Particle 5

| | |
|---|---|
| Amorphous polyester resin 1 | 74 parts |
| Crystalline polyester resin 4 | 12 parts |
| Carbon black (product name: #25B manufactured by | 6 parts |
| Mitsubishi Chemical Corporation) | |
| Charge-controlling agent (produce name: BONTRON N-01, | 2 parts |
| manufactured by Orient Chemical Industries Co., Ltd.) | |
| Paraffin wax (product name: HNP9 manufactured by NIPPON | 6 parts |
| SEIRO CO., LTD.) | |

The compositions described above are powder-mixed by a Henschel mixer, this is heat-kneaded by an extruder having a set temperature of 100° C., and cooled, and then, coarse pulverizing, fine pulverizing, and classification are performed.

Air heating treatment is performed with a thermal shaping device “Surfusing System SFS-3 type” (manufactured by Nippon Pneumatic Mfg. Co., Ltd.), and a toner base particle 5 having a volume average particle size D50 of 6.7 μm is obtained.

### Preparation of Toner 36

| | | |
|---|---|---|
| Toner base particle 5 | 100 | parts |
| Silica particle (product name: RA200H manufactured by | 0.6 | part |
| NIPPON AEROSIL CO., LTD) | | |
| Silicone oil-treated inorganic particle 1 | 1.5 | parts |
| Organic particle 1 | 1.0 | part |

The compositions described above are mixed in the Henschel mixer, and toner 36 is obtained.

### Preparation of Toner 37

### Preparation of Toner Base Particle 6

| | |
|---|---|
| Amorphous polyester resin 1 | 72 parts |
| Crystalline polyester resin 5 | 14 parts |
| Carbon black (product name: #25B manufactured by | 6 parts |
| Mitsubishi Chemical Corporation) | |
| Charge-controlling agent (produce name: BONTRON N-01, | 2 parts |
| manufactured by Orient Chemical Industries Co., Ltd.) | |
| Paraffin wax (product name: HNP9 manufactured by NIPPON | 6 parts |
| SEIRO CO., LTD.) | |

The compositions described above are powder-mixed by a Henschel mixer, this is heat-kneaded by an extruder having a set temperature of 100° C., and cooled, and then, coarse pulverizing, fine pulverizing, and classification are performed.

Air heating treatment is performed with a thermal shaping device “Surfusing System SFS-3 type” (manufactured by Nippon Pneumatic Mfg. Co., Ltd.), and a toner base particle 6 having a volume average particle size D50 of 7.0 μm is obtained.

### Preparation of Toner 37

| | | |
|---|---|---|
| Toner base particle 6 | 100 | parts |
| Silica particle (product name: RA200H manufactured by | 0.6 | part |
| NIPPON AEROSIL CO., LTD) | | |
| Silicone oil-treated inorganic particle 1 | 1.5 | parts |
| Organic particle 1 | 1.0 | part |

The compositions described above are mixed in the Henschel mixer, and toner 37 is obtained.

Evaluation results of the toner 1 to 37 are shown in Table 1.

TABLE 1

| | | Base | Crystalline resin | | Organic particle | | | | |
|---|---|---|---|---|---|---|---|---|---|
| | Toner | particle | | Melting | | | | Number | |
| | Type | Type | Type | temperature | Type | | Average | average particle | Content |
| | (No.) | (No.) | (No.) | (° C.) | (No.) | Material | circularity | size (μm) | w1 |
| Ex. 1 | 1 | 1 | 1 | 70 | 1 | Fatty acid ester | 0.85 | 4.5 | 1.0 |
| Ex. 2 | 2 | 1 | 1 | 70 | 2 | Fatty acid amide | 0.88 | 5.4 | 1.0 |
| Ex. 3 | 3 | 1 | 1 | 70 | 3 | Higher fatty acid | 0.86 | 6.2 | 1.0 |
| Ex. 4 | 4 | 1 | 1 | 70 | 4 | Higher alcohol | 0.82 | 5.1 | 1.0 |
| Ex. 5 | 5 | 2 | 2 | 53 | 1 | Fatty acid ester | 0.85 | 4.5 | 1.0 |
| Ex. 6 | 6 | 3 | 3 | 98 | 1 | Fatty acid ester | 0.85 | 4.5 | 1.0 |
| Ex. 7 | 7 | 1 | 1 | 70 | 5 | Fatty acid ester | 0.68 | 10.2 | 1.0 |
| Ex. 8 | 8 | 1 | 1 | 70 | 6 | Fatty acid ester | 0.73 | 8.9 | 1.0 |
| Ex. 9 | 9 | 1 | 1 | 70 | 7 | Fatty acid amide | 0.94 | 5.1 | 1.0 |
| Ex. 10 | 10 | 1 | 1 | 70 | 8 | Fatty acid amide | 0.97 | 4.9 | 1.0 |
| Ex. 11 | 11 | 1 | 1 | 70 | 9 | Fatty acid ester | 0.89 | 0.4 | 1.0 |
| Ex. 12 | 12 | 1 | 1 | 70 | 10 | Fatty acid ester | 0.87 | 0.7 | 1.0 |
| Ex. 13 | 13 | 1 | 1 | 70 | 11 | Fatty acid amide | 0.82 | 14.6 | 1.0 |
| Ex. 14 | 14 | 1 | 1 | 70 | 12 | Fatty acid amide | 0.81 | 15.2 | 1.0 |
| Ex. 15 | 15 | 1 | 1 | 70 | 1 | Fatty acid ester | 0.85 | 4.5 | 1.0 |
| Ex. 16 | 16 | 1 | 1 | 70 | 1 | Fatty acid ester | 0.85 | 4.5 | 1.0 |
| Ex. 17 | 17 | 1 | 1 | 70 | 1 | Fatty acid ester | 0.85 | 4.5 | 1.0 |
| Ex. 18 | 18 | 1 | 1 | 70 | 1 | Fatty acid ester | 0.85 | 4.5 | 1.0 |
| Ex. 19 | 19 | 1 | 1 | 70 | 1 | Fatty acid ester | 0.85 | 4.5 | 0.2 |
| Ex. 20 | 20 | 1 | 1 | 70 | 1 | Fatty acid ester | 0.85 | 4.5 | 0.3 |
| Ex. 21 | 21 | 1 | 1 | 70 | 1 | Fatty acid ester | 0.85 | 4.5 | 1.7 |
| Ex. 22 | 22 | 1 | 1 | 70 | 1 | Fatty acid ester | 0.85 | 4.5 | 2.3 |
| Ex. 23 | 23 | 1 | 1 | 70 | 2 | Fatty acid amide | 0.88 | 5.4 | 0.08 |
| Ex. 24 | 24 | 1 | 1 | 70 | 2 | Fatty acid amide | 0.88 | 5.4 | 0.15 |
| Ex. 25 | 25 | 1 | 1 | 70 | 2 | Fatty acid amide | 0.88 | 5.4 | 4.8 |
| Ex. 26 | 26 | 1 | 1 | 70 | 2 | Fatty acid amide | 0.88 | 5.4 | 5.2 |
| Ex. 27 | 27 | 1 | 1 | 70 | 1 | Fatty acid ester | 0.85 | 4.5 | 0.45 |
| Ex. 28 | 28 | 1 | 1 | 70 | 1 | Fatty acid ester | 0.85 | 4.5 | 0.6 |
| Ex. 29 | 29 | 1 | 1 | 70 | 1 | Fatty acid ester | 0.85 | 4.5 | 2.2 |
| Ex. 30 | 30 | 1 | 1 | 70 | 1 | Fatty acid ester | 0.85 | 4.5 | 2.4 |
| Ex. 31 | 31 | 4 | 1 | 70 | 1 | Fatty acid ester | 0.85 | 4.5 | 1.1 |
| Com. Ex. 1 | 32 | 1 | 1 | 70 | — | — | — | — | — |
| Com. Ex. 2 | 33 | 1 | 1 | 70 | 13 | Polyethylene | 0.83 | 6.4 | 1.0 |
| Com. Ex. 3 | 34 | 1 | 1 | 70 | 1 | Fatty acid ester | 0.85 | 4.5 | 1.0 |
| Com. Ex. 4 | 35 | 1 | 1 | 70 | 1 | Fatty acid ester | 0.85 | 4.5 | 1.0 |
| Com. Ex. 5 | 36 | 5 | 4 | 47 | 1 | Fatty acid ester | 0.85 | 4.5 | 1.0 |
| Com. Ex. 6 | 37 | 6 | 5 | 105 | 1 | Fatty acid ester | 0.85 | 4.5 | 1.0 |

| | Silicone oil-treated inorganic particle | | | | | |
|---|---|---|---|---|---|---|
| | | Inorganic particle | Free | | Ratio of | Evaluation |
| | Type | number average | silicone oil | Content | external additive | Half-tone |
| | (No.) | particle size (nm) | amount (%) | w2 | w1/w2 | image |
| Ex. 1 | 1 | 120 | 7 | 1.5 | 0.67 | A |
| Ex. 2 | 1 | 120 | 7 | 1.5 | 0.67 | A |
| Ex. 3 | 1 | 120 | 7 | 1.5 | 0.67 | B |
| Ex. 4 | 1 | 120 | 7 | 1.5 | 0.67 | B |
| Ex. 5 | 1 | 120 | 7 | 1.5 | 0.67 | B |
| Ex. 6 | 1 | 120 | 7 | 1.5 | 0.67 | B |
| Ex. 7 | 1 | 120 | 7 | 1.5 | 0.67 | C |
| Ex. 8 | 1 | 120 | 7 | 1.5 | 0.67 | B |
| Ex. 9 | 1 | 120 | 7 | 1.5 | 0.67 | B |
| Ex. 10 | 1 | 120 | 7 | 1.5 | 0.67 | C |
| Ex. 11 | 1 | 120 | 7 | 1.5 | 0.67 | C |
| Ex. 12 | 1 | 120 | 7 | 1.5 | 0.67 | B |
| Ex. 13 | 1 | 120 | 7 | 1.5 | 0.67 | B |
| Ex. 14 | 1 | 120 | 7 | 1.5 | 0.67 | C |
| Ex. 15 | 2 | 200 | 2 | 1.5 | 0.67 | C |
| Ex. 16 | 3 | 180 | 4 | 1.5 | 0.67 | B |
| Ex. 17 | 4 | 65 | 18 | 1.5 | 0.67 | B |
| Ex. 18 | 5 | 55 | 22 | 1.5 | 0.67 | C |
| Ex. 19 | 6 | 150 | 5 | 4.5 | 0.04 | C |
| Ex. 20 | 6 | 150 | 5 | 5.0 | 0.06 | B |
| Ex. 21 | 7 | 80 | 13 | 0.5 | 3.4 | C |
| Ex. 22 | 7 | 80 | 13 | 0.8 | 2.9 | B |
| Ex. 23 | 1 | 120 | 7 | 0.6 | 0.13 | C |
| Ex. 24 | 1 | 120 | 7 | 0.6 | 0.25 | B |
| Ex. 25 | 1 | 120 | 7 | 3.0 | 1.6 | B |
| Ex. 26 | 1 | 120 | 7 | 3.4 | 1.5 | C |
| Ex. 27 | 1 | 120 | 7 | 0.25 | 1.8 | C |
| Ex. 28 | 1 | 120 | 7 | 0.35 | 1.7 | B |
| Ex. 29 | 1 | 120 | 7 | 5.8 | 0.38 | B |
| Ex. 30 | 1 | 120 | 7 | 6.3 | 0.38 | C |
| Ex. 31 | 1 | 120 | 7 | 1.2 | 0.92 | A |
| Com. Ex. 1 | 1 | 120 | 7 | 1.5 | 0 | D |
| Com. Ex. 2 | 1 | 120 | 7 | 1.5 | 0 | D |
| Com. Ex. 3 | — | — | — | — | — | D |
| Com. Ex. 4 | HMDS | 120 | 0 | 1.5 | — | D |
| Com. Ex. 5 | 1 | 120 | 7 | 1.5 | 0.67 | D |
| Com. Ex. 6 | 1 | 120 | 7 | 1.5 | 0.67 | D |

### Examples 32 to 35

Using the toner used in Example 1, the evaluation is performed in the same manner as Example 1 except for changing the relative rate of the development roll with respect to the image holding member as described above.

The results are shown in Table 2.

TABLE 2

| | Relative rate of development roll with | | |
|---|---|---|---|
| | respect to image holding member | | Half-tone image |
| Example 1 | 1.8 | times | A |
| Example 32 | 1.1 | times | A |
| Example 33 | 2.5 | times | A |
| Example 34 | 1.0 | time | B |
| Example 35 | 2.6 | times | B |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-magnetic single-component toner comprising:
a toner base particle that contains at least a binder resin and a colorant, and an external additive,
wherein the external additive includes an organic particle and an inorganic particle,
the binder resin contains at least an amorphous polyester resin and a crystalline polyester resin,
an endothermic peak of the crystalline polyester resin obtained by differential scanning calorimetry is from 50° C. to 100° C.,
the organic particle contains at least one kind selected from a group consisting of higher fatty acid, higher alcohol, fatty acid ester, and fatty acid amide, and
the inorganic particle is treated with silicone oil.

2. The non-magnetic single-component toner according to claim 1, wherein the organic particle contains fatty acid ester and/or fatty acid amide.

3. The non-magnetic single-component toner according to claim 1, wherein an average circularity of the organic particle is from 0.70 to 0.95.

4. The non-magnetic single-component toner according to claim 1, wherein a number average particle size of the organic particle is from 0.5 μm to 15 μm.

5. The non-magnetic single-component toner according to claim 1, wherein the organic particle is solid at 25° C., and a melting point is equal to or higher than 50° C.

6. The non-magnetic single-component toner according to claim 1, wherein the higher fatty acid is saturated fatty acid having 12 or more carbon atoms.

7. The non-magnetic single-component toner according to claim 1, wherein the higher alcohol is a monovalent aliphatic alcohol having 14 or more carbon atoms.

8. The non-magnetic single-component toner according to claim 1, wherein the fatty acid ester is ester of a monovalent fatty acid and a monovalent or polyvalent aliphatic alcohol.

9. The non-magnetic single-component toner according to claim 1, wherein the fatty acid amide is at least one kind selected from a group consisting of saturated fatty acid amide, unsaturated fatty acid amide, and N-substituted fatty acid amide.

10. The non-magnetic single-component toner according to claim 1, wherein, in the silicone oil-treated inorganic particle, an amount of free silicone oil with respect to the weight of the inorganic particle is from 3% by weight to 20% by weight.

11. The non-magnetic single-component toner according to claim 1, wherein, when the content of the organic particle is set to w1 parts by weight and the content of the inorganic particle is set to w2 parts by weight with respect to 100 parts by weight of the toner base particle, w1/w2 is from 0.05 to 3.0.

12. The non-magnetic single-component toner according to claim 1, wherein an added amount of the organic particle with respect to 100 parts by weight of the toner base particle is from 0.1 part by weight to 5 parts by weight.

13. The non-magnetic single-component toner according to claim 1, wherein an added amount of the inorganic particle with respect to 100 parts by weight of the toner base particle is from 0.3 part by weight to 6 parts by weight.

14. The non-magnetic single-component toner according to claim 1, wherein an added amount of the inorganic particle with respect to 100 parts by weight of the toner base particle is from 0.4 part by weight to 5.5 parts by weight.

15. The non-magnetic single-component toner according to claim 1, wherein the non-magnetic single-component toner has a positive charging property.

16. The non-magnetic single-component toner according to claim 1, wherein a number average particle size of the silicone oil-treated inorganic particle is from 20 nm to 800 nm.

17. The non-magnetic single-component toner according to claim 1, wherein a weight-average molecular weight of the binder resin is from 4,000 to 100,000.

18. The non-magnetic single-component toner according to claim 1, wherein a content of the crystalline polyester resin with respect to toner is from 3% by weight to 40% by weight.

19. An electrostatic charge image developer containing the non-magnetic single-component toner according to claim 1.

20. A process cartridge that is detachable from an image forming apparatus, accommodates the electrostatic charge image developer according to claim 19, and includes a development unit that develops an electrostatic latent image formed on a surface of an image holding member by the electrostatic charge image developer to form a toner image.
